(19) United States
(12) Patent Application Publication
(10) Pub. No.: US 2007/0248027 A1
(43) Pub. Date: Oct. 25, 2007

(54) Providing a configuration utility for a remote terminal unit

(75) Inventors: James P. Roberts, Maple Grove, MN (US); Andrew J. Fredman, Crystal, MN (US)

Correspondence Address: Merchant & Gould P.C., P.O. Box 2903, Minneapolis, MN, 55402-0903, US

(73) Assignee: Open Systems International

(21) Appl. No.: 11/410,819

(22) Filed: Apr. 25, 2006

(51) Int. Cl. H04L 12/28

(52) U.S. Cl. 370/254

(57) ABSTRACT

Systems and methods are disclosed for providing a configuration utility. The systems and methods may include receiving, at the remote terminal unit, a first request for a page. The page may include a link associated with the configuration utility that may be transmitted from the remote terminal unit. The configuration utility may be stored on the remote terminal unit and configured to create, based on user input, a configuration file for the remote terminal unit. Next, a second request corresponding to the link to the configuration utility may be received at the remote terminal unit. The configuration utility may be transmitted from the remote terminal unit, in response to the second request. Moreover, the configuration file may be received at the remote terminal unit. The configuration file may be configured to cause the remote terminal unit to operate in a first manner selected, based upon user input, from a plurality of manners.

### BACKGROUND

I. Field of the Invention

The present invention generally relates to methods and systems for providing a configuration utility. More particularly, the present invention relates to providing a configuration utility, for example, for a remote terminal unit.

II. Background Information

A supervisory control and data acquisition (SCADA) system, is a computer system for gathering and analyzing real time data. SCADA systems may be used to monitor and control equipment in industries such as electric utilities, telecommunications, water and waste control, energy, oil and gas refining, and transportation. A SCADA system may gather information, such as where a leak on a pipeline has occurred, from equipment in a remote location. This information may then be transferred to a SCADA master processor at a central location, alerting the SCADA master processor that the leak has occurred. The SCADA master processor may then carry out any necessary analysis and control, such as determining if the leak is critical, and displaying the information in a logical and organized fashion to a SCADA operator. SCADA systems can be simple, such as one that monitors environmental conditions of a small office building, or complex, such as a system that monitors all the activity in a nuclear power plant or the activity of a large municipal water system.

A remote terminal unit (RTU) is one element in a SCADA system. In the above example, the RTU may gather the information from the equipment in a remote location and send the gathered information to the SCADA master processor. The information may be sent from the RTU to the SCADA master over a wired or wireless network. Specifically, the RTU may be equipped with input/output (I/O) channels. For example, the I/O may include channels for sensing or metering, output channels for control initiated from the SCADA master, and other channels for indications or alarms.

In order to function, the RTU must be configured. In some situations, an RTU's manufacturer may supply a utility on a diskette or compact disk to aid a user in determining a configuration and creating a configuration file associated with the determined configuration. When used by the RTU, the configuration file may implement the determined configuration. Thus, the conventional strategy is for the RTU's manufacturer to supply the configuration utility on a diskette or compact disk. This often causes problems because the conventional strategy does not easily allow users to obtain the configuration utility. For example, many users do not catalog or otherwise retain the configuration utility supplied by the RTU's manufacturer. Furthermore, different versions of an RTU may require corresponding different versions of a configuration utility. For example, even if RTUs visually appear to be the same model, they may require different configuration utilities. In conventional systems, the configuration utility on a diskette or compact disk must be cataloged by an RTU's serial number and placed in a software library.

In view of the foregoing, there is a need for methods and systems for providing a configuration utility more optimally. Furthermore, there is a need for providing a configuration utility for a remote terminal unit.

### SUMMARY

Systems and methods are disclosed for providing a configuration utility for a remote terminal unit. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one embodiment, a method for providing a configuration utility for a remote terminal unit comprises receiving, at the remote terminal unit, a first request for a page. The method may further include transmitting, from the remote terminal unit, the page including a link associated with the configuration utility. The configuration utility may be stored on the remote terminal unit and configured to create, based on user input, a configuration file for the remote terminal unit. In addition, the method may include receiving, at the remote terminal unit, a second request corresponding to the link to the configuration utility and transmitting from the remote terminal unit, in response to the second request, the configuration utility.

According to another embodiment, a remote terminal unit configured for providing a configuration utility may comprise a memory storage and a processing unit coupled to the memory storage. The processing unit may be operative to receive, at the remote terminal unit, a first request for a page. The processing unit may be further operative to transmit, from the remote terminal unit, the page including a link associated with the configuration utility. The configuration utility may be stored on the remote terminal unit and configured to create, based on user input, a configuration file for the remote terminal unit. In addition, the processing unit may be further operative to receive, at the remote terminal unit, a second request corresponding to the link to the configuration utility and to transmit from the remote terminal unit, in response to the second request, the configuration utility.

In accordance with yet another embodiment, a remote terminal unit may comprise a remote terminal unit processor and an input/output component electrically isolated from the remote terminal unit processor. The remote terminal unit processor and the input/output component may both be located on a first circuit board wherein a first space may be maintained on the circuit board between the remote terminal unit processor and the input/output component. The first space may have a first width configured to cause the remote terminal unit processor to be isolated from an electrical surge between the remote terminal unit processor and the input/output component.

In accordance with yet another embodiment, a computer-readable medium which stores a set of instructions which when executed performs a method for providing a configuration utility for a remote terminal unit, the method executed by the set of instructions. The set of instructions may include receiving, at the remote terminal unit, a first request for a page. The set of instructions may further include transmitting, from the remote terminal unit, the page including a link associated with the configuration utility. The configuration utility may be stored on the remote terminal unit and configured to create, based on user input, a configuration file for the remote terminal unit. In addition, the set of instructions may include receiving, at the remote terminal unit, a second request corresponding to the link to the configuration utility. Moreover, the set of instructions may include transmitting from the remote terminal unit, in response to the second request, the configuration utility. The set of instructions may also include receiving, at the remote terminal unit, the configuration file configured to cause the remote terminal unit to operate in a first manner selected, based upon user input, from a plurality of manners. The configuration file created by the configuration utility may be received from the remote terminal unit and executed on a user processor.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary operating environment consistent with an embodiment of the present invention;

FIG. 2 is a block diagram of an exemplary remote terminal unit consistent with an embodiment of the present invention;

FIG. 3 is a block diagram of an exemplary remote terminal unit consistent with an embodiment of the present invention; and

FIG. 4 is a flow chart of an exemplary method for providing a configuration utility for a remote terminal unit consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding stages to the disclosed methods. Accordingly, the following detailed description does not limit the invention. Instead, the proper scope of the invention is defined by the appended claims.

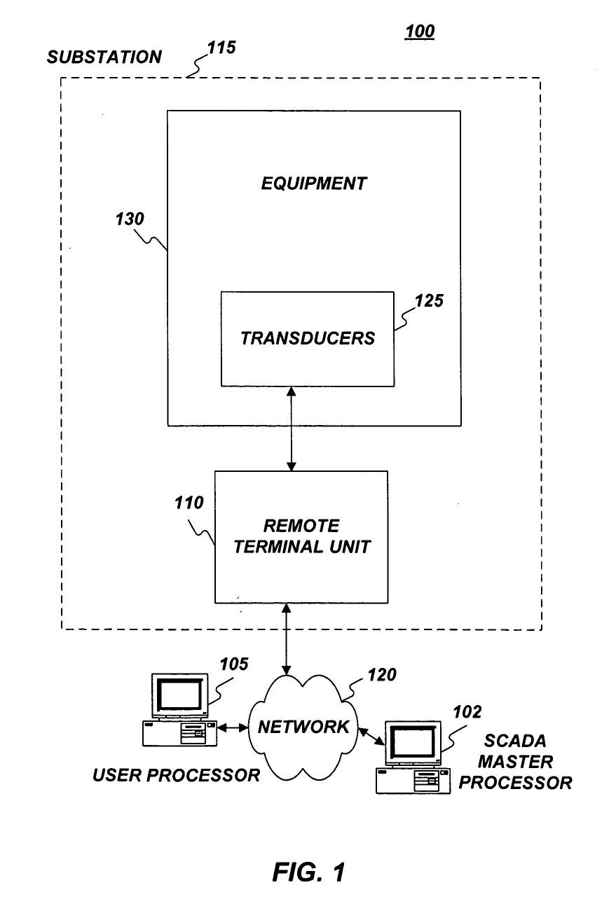

Systems and methods consistent with embodiments of the present invention provide a configuration utility for a remote terminal unit. FIG. 1 is a block diagram of an exemplary SCADA system 100 consistent with an embodiment of the present invention. As shown in FIG. 1, SCADA system 100 may include a SCADA master processor 102, a user processor 105, an RTU 110, a substation 115, a network 120, transducers 125, and equipment 130. SCADA master processor 102 may carry out any necessary analysis and control, such as determining the status of equipment 130 in substation 115, and displaying the determined status in a logical and organized fashion to a SCADA operator. For example, equipment 130 may comprise an electrical breaker. The aforementioned status determination may comprise checking whether the electrical breaker is open or closed. Furthermore, the SCADA operator, through SCADA master processor 102, may transmit a control signal to open or close the breaker. In order to perform the aforementioned status check or control signal transmission, SCADA master processor 102 may communicate with RTU 110 over network 120. Furthermore, RTU 110 may obtain status information or send and receive control signals to equipment 130 through transducers 125.

User processor 105 may communicate with remote terminal unit 110 over network 120. Furthermore, user processor 105 may connect to remote terminal unit 110 via a wire. Consistent with an embodiment of the invention, and as described in more detail below, RTU 110 may function as a web server and supply pages to user processor 105 or to SCADA master processor 120. Moreover, through the supplied pages, RTU 110 may supply a link to user processor 105. The link may enable user processor 105 to upload a configuration utility from RTU 110. Using the configuration utility, a user may create a configuration file on user processor 105. From user processor, the user may then download the created configuration file into RTU 110. The uploaded configuration utility may be specific to RTU 110 and may only produce configuration files for RTU 110 or other RTUs being very similar to RTU 110. For example, the uploaded configuration utility may produce configuration files for RTUs manufactured during a certain time period, having a particular serial number, or having a certain model number. The aforementioned are exemplary, and the uploaded configuration utility may produce configuration files for RTUs being distinguished or identified in other ways.

An embodiment consistent with the invention may comprise an RTU. The RTU may comprise a memory storage for maintaining a database and a processing unit coupled to the memory storage. The processing unit may be operative to receive a first request for a page. In addition, the processing unit may be operative to transmit, from the RTU, the page including a link associated with the configuration utility. The configuration utility may be stored on the RTU and configured to create, based on user input, a configuration file for the RTU. Furthermore, the processing unit may be operative to receive a second request corresponding to the link to the configuration utility. Moreover, the processing unit may be operative to transmit from the RTU, in response to the second request, the configuration utility.

Consistent with an embodiment of the present invention, the aforementioned memory, processing unit, and other components may be implemented in a SCADA system, such as an exemplary SCADA system 100 of FIG. 1. Any suitable combination of hardware, software, and/or firmware may be used to implement the memory, processing unit, or other components. By way of example, the memory, processing unit, or other components may be implemented with remote terminal unit 110, in combination with system 100. The aforementioned system and processors are exemplary and other systems and processors may comprise the aforementioned memory, processing unit, or other components, consistent with embodiments of the present invention.

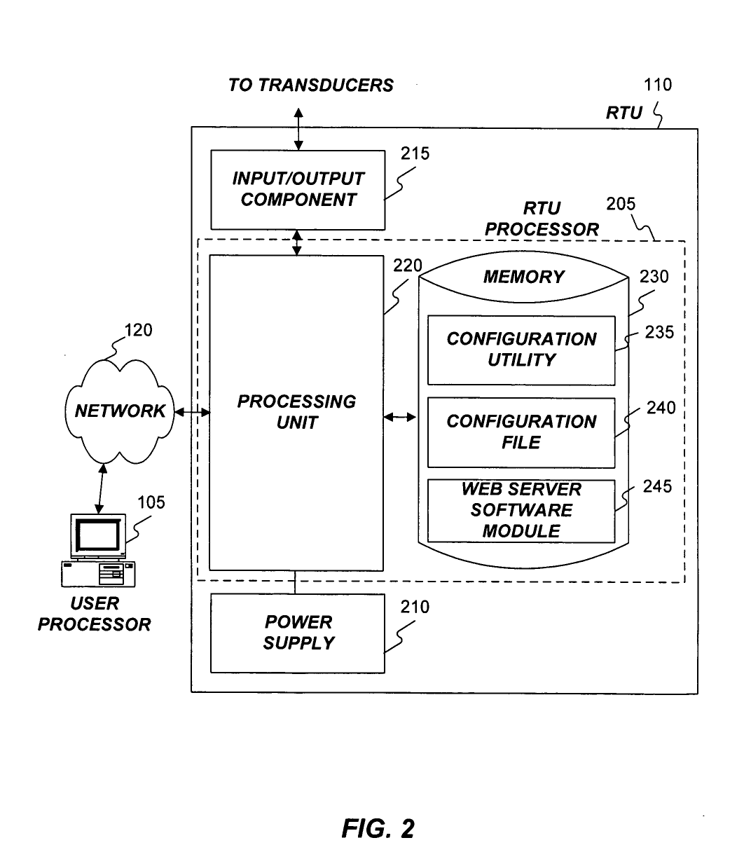

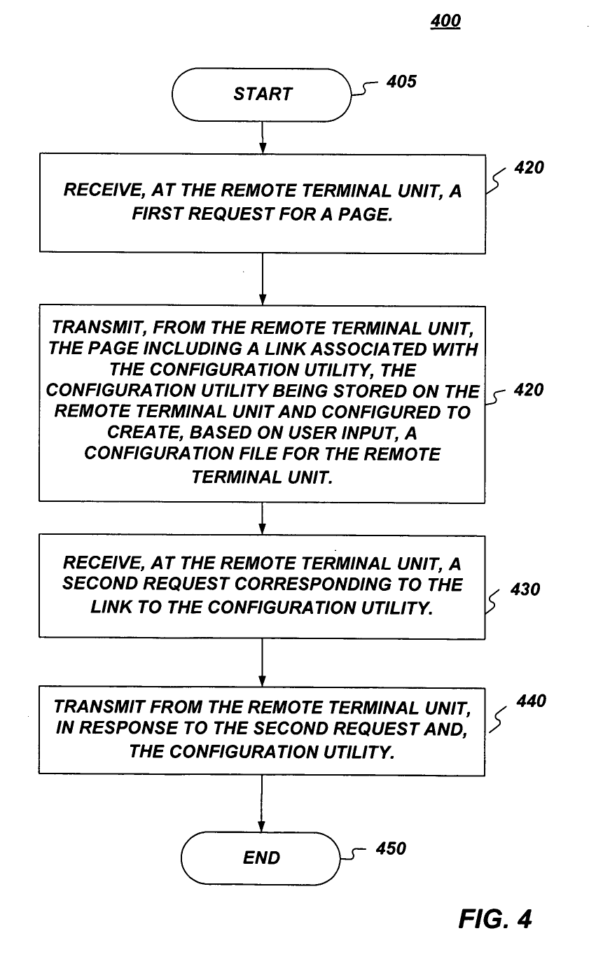

FIG. 2 shows remote terminal unit 110 of FIG. 1 in more detail. As shown in FIG. 2, remote terminal unit 110 may include an RTU processor 205, a power supply 210, and an input/output component 215. Power supply 210 may supply power to RTU processor 205. Input/output component 215 may comprise components for sending output to or receiving input from equipment 130 through transducers 125. Signals transmitted and received through input/output component 215 may comprise digital and/or analog signals. Remote terminal unit processor 205 may include a processing unit 220 and a memory 230. Memory 230 may include a configuration utility 235, a configuration file 240, and a web server software module 245. While executing on processing unit 220, web server software module 245 may perform processes for providing configuration utility 235 for remote terminal unit 110, including, for example, one or more of the stages of method 400 described below with respect to FIG. 4.

SCADA master processor 102 or user processor 105 (“the processors”) included in system 100 may be implemented using a personal computer, network computer, mainframe, or other similar microcomputer-based workstation. The processors may though comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Network 120 may comprise, for example, a local area network (LAN) or a wide area network (WAN). Such networking environments are commonplace in offices, enterprise-wide computer networks, intranets, and the Internet. When a LAN is used as network 120, a network interface located at any of the processors may be used to interconnect any of the processors. When network 120 is implemented in a WAN networking environment, such as the Internet, the processors may typically include an internal or external modem (not shown) or other means for establishing communications over the WAN. Further, in utilizing network 120, data sent over network 120 may be encrypted to insure data security by using known encryption/decryption techniques.

In addition to utilizing a wire line communications system as network 120, a wireless communications system, or a combination of wire line and wireless may be utilized as network 120 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission. For example, the processors may communicate across a wireless interface such as, for example, a cellular interface (e.g., general packet radio system (GPRS), enhanced data rates for global evolution (EDGE), global system for mobile communications (GSM), code division multiple access 2000 (CDMA2000)), a wireless local area network interface (e.g., WLAN, IEEE 802.11), a wireless personal area network interface (e.g., WPAN, Bluetooth, ZigBee), another RF communication interface, and/or an optical interface.

System 100 may also transmit data by methods and processes other than, or in combination with, network 120. These methods and processes may include, but are not limited to, transferring data via, diskette, flash memory sticks, CD ROM, facsimile, conventional mail, an interactive voice response system (IVR), or via voice over a publicly switched telephone network.

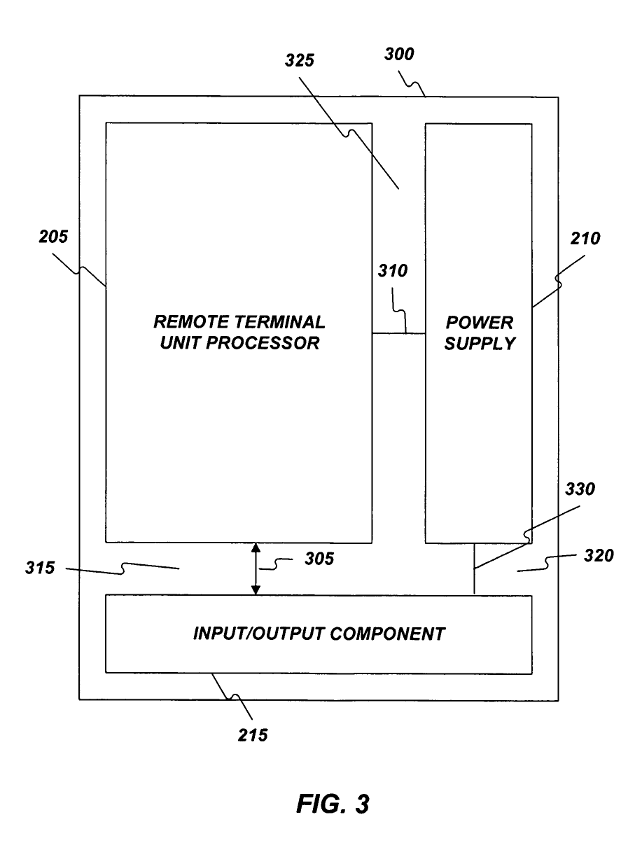

FIG. 3 is a block diagram of an exemplary remote terminal unit consistent with another embodiment of the present invention. In order to protect various parts of an RTU from electrical surges, conventional systems construct an RTU on several circuit boards. In this way surges may not arc across the several circuit boards in conventional systems. However, having several circuit boards cause RTUs in conventional systems to be larger. In addition, several boards also cause boards to be more likely to fail, because the interconnections used between boards may be affected by environmental (e.g. temperature) fluctuations.

As shown in FIG. 3, RTU 110 may be constructed on a single circuit board 300. Constructing RTU 110 on a single circuit board 300 may allow RTU 110 to be more compact than conventional systems.

Consistent with another embodiment of the invention, at least in order to protect the RTU from electrical surges, a space on a circuit board comprising an RTU may be maintained. The space may be maintained between portions of the RTU that are more sensitive to electrical surges and those portions from which an electrical surge may originate. The amount of space maintained may be determined by the environment in which the RTU is to be operated. For example, if the RTU is to be operated in an electrical substation, the amount of space maintained may be determined by the electrical surge magnitudes expected in an electrical substation.

As shown in FIG. 3, RTU 110 may be constructed on a single circuit board 300. On circuit board 300, portions of RTU 110 may be separated. For example, RTU processor 205 may be separated from input/output component 215 by a first space 315. However, RTU processor 205 may communicate with input/output component 215 via a coupler 305. Coupler 305 may comprise, but is not limited to, an optical coupling device. Coupler 305 may comprise an element capable of communicatively coupling RTU processor 205 with input/output component 215 while maintaining electrical isolation. In other words, coupler 305 may not provide a path for an electrical surge between RTU processor 205 and input/output component 215.

Also, RTU processor 205 may be separated from power supply 210 by a second space 325. However, RTU processor 205 may connect to power supply 210 via a fist energy transfer element 310. First energy transfer element 310 may comprise an element capable of transferring energy from power supply 210 to RTU processor 205 while maintaining electrical surge isolation. In other words, first energy transfer element 310 may not provide a path for an electrical surge between RTU processor 205 and power supply 210. First energy transfer element 310 may comprise, but is not limited to, an isolation transformer having, for example, high dielectric insulation on its windings. Furthermore, input/output component 215 may connect to power supply 210 via a second energy transfer element 330. Second energy transfer element 330 may comprise an element capable of transferring energy from power supply 210 to input/output component 215 while maintaining electrical surge isolation. In other words, second energy transfer element 330 may not provide a path for an electrical surge between input/output component 215 and power supply 210. Second energy transfer element 330 may comprise, but is not limited to, an isolation transformer having, for example, high dielectric insulation on its windings.

In this embodiment of FIG. 3, RTU processor 205 may comprise a main microprocessor and all communications ports (e.g. ethernet, serial, USB, CompactFlash, etc.) These communications ports may be isolated to protect sensitive telecommunications equipment from voltage surges as well as to protect RTU processor 205 from surges on any telecommunications lines. Input/output component 215 may contain analog inputs, digital inputs, and digital outputs. Input/output component 215 may be isolated to contain voltage surges, preventing them from feeding back along any communications or power lines.

First space 315 may have a width configured to cause RTU processor 205 processor to be isolated from an electrical surge between RTU processor 205 and input/output component 215. For example, first space 315 may be wide enough to cause RTU processor 205 to be isolated from an electrical surge of less than or equal to 2.5 kV oscillatory and 4 kV transient. Furthermore, second space 325 may have a width configured to cause RTU processor 205 processor to be isolated from an electrical surge originating from power supply 210. For example, second space 325 and third space 320 may be wide enough to cause RTU processor 205 to be isolated from an electrical surge of less than or equal to 2.5 kV oscillatory and 4 kV transient.

In determining first space 315, second space 325, or third space 320, IEEE C37.90.1-2002: IEEE Standard for Surge Withstand Capability (SWC) Tests for Relays and Relay Systems Associated with Electric Power Apparatus may be used. Consequently, first space 315 or second space 325 may be wide enough to withstand a transient (e.g. 4 kV) and oscillatory (e.g. 2.5 kV) waveform applied in transverse and/or common mode to any power inputs, I/O input or outputs, or communication lines associated with RTU 110. In determining first space 315, second space 325, or third space 320 (i.e. to make them wide enough to withstand a surge), the following objectives (e.g. from IEEE C37.90.1) may be observed: i) equipment performance does not change beyond stated tolerances; ii) no hardware damage; iii) no change in calibration beyond stated tolerances; iv) no loss or corruption of stored data; v) system resets do not occur, manual resetting not required; vi) communications, if disrupted, recover within stated time period; vii) communication errors do not jeopardize protective functions; and viii) no changes in the electrical, mechanical, or communication status outputs occur.

To meet any of these objectives, for example, it may be important to dampen or completely stop any transients from getting to any sensitive circuitry on circuit board 300. Both transient suppression and isolation may be used to decrease or eliminate transients. Transient suppression may be used on any communications ports, the power input, and digital/analog inputs. The amount or strength of transient suppression may depend on the sensitivity of the circuitry involved. For example, on circuit board 300, an area of roughly three square inches may be used to place protection circuitry for the eight analog inputs, and no protection may be used for eight digital outputs because of protection that may be inherent to the relay components used.

Isolation caused by first space 315, second space 325, or third space 320 may be used as a general barrier for transients as well as direct current (DC) differences between the various areas of circuit board 300. For example, DC isolation (not transient) may be based on “creepage and clearance” rules found in common safety standards (from Underwriters Laboratory of 333 rPfingsten Road, Northbrook, Ill. 60062-2096 or from IEC, 3, rue de Varembé, P.O. Box 131, CH-1211 GENEVA 20, Switzerland.) Creepage may comprise the shortest path between two conductive parts on circuit board 300 measured, for example, along the surface of the insulation. Clearance may be the shortest distance between two conductive parts measured through the air. These distances may vary, for example, due to pollution levels (i.e. how dirty the environment), levels of insulation (depending on the application; commercial, industrial, etc.), or overvoltage category.

The creepage and clearance guidelines provide helpful information as to how high voltages migrate over time, how pollution levels matter when considering distances, and how it may be important to have multiple levels of protection if possible. However, transient protection may also be considered. Consistent with an embodiment of the invention, a 130 mil. spacing may be used between all layers on circuit board 300. Furthermore, internal layers may be insulated to 5 kV for spacings of 7 mils or more. External layers with solder mask (e.g. circuit board 300 may have solder mask on all traces) may use a 40 mil. spacing for 4.7 kV isolation on a clean board. Bringing traces, for example, out to coupler 305 (e.g. opto-coupler) and first energy transfer element 310 and/or and second energy transfer element 330 exposes the traces (no mask.)

Embodiments of the invention may be used in an industrial (e.g. high board-level pollution) environment. Accordingly, circuit board 300 may be exposed, for example, to hygroscopic dust. In this case, for example, a 100 mil spacing used may only provide 3.6 kV of isolation. The trend, however, may be linear, thus a 110 mil spacing may provide approximately 4 kV isolation. Consequently, first space 315 and second space 325 may comprise a 130 mil spacing to insure at least a 4 kV isolation level (e.g. adding 20 mils to the aforementioned 110 mil as a precaution.) Isolation level calculations are described in “PCB Layout: The Impact of Lightening and Power-Cross Transients,” Hilliard, Milton, Compliance Engineering January-February 2003, 10 Jan. 2006 <http://www.ce-mag.com/archive/03/01/hilliard.html>, which is incorporated herein by reference.

FIG. 4 is a flow chart setting forth the general stages involved in an exemplary method 400 consistent with the invention for providing a configuration utility for a remote terminal unit using system 100 of FIG. 1. Exemplary ways to implement the stages of exemplary method 400 will be described in greater detail below. Exemplary method 400 may begin at starting block 405 and proceed to stage 410 where remote terminal unit 110 may receive a first request for a page. For example, RTU processor 205 may function as a web server. Executing on processing unit 220, web server software module 245 may cause RTU processor 205 to send and receive pages. For example, through network 120, user processor 105 may request a page from RTU processor 205. In another embodiment, user processor 105 and RTU 110 may be in close proximity and user processor 105 and RTU processor 205 may communicate over a cable between user processor 105 and RTU 110.

From stage 410, where remote terminal unit 110 receives the first request for the page, exemplary method 400 may advance to stage 420 where remote terminal unit 110 may transmit the page including a link associated with configuration utility 235. Configuration utility 235 may be stored on remote terminal unit 110 and may be configured to create, based on user input, a configuration file for remote terminal unit 110. For example, remote terminal unit 110 may transmit the page including the link associated with configuration utility 235 to user processor 105.

Once remote terminal unit 110 transmits the page including the link associated with the configuration utility in stage 420, exemplary method 400 may continue to stage 430 where remote terminal unit 110 may receive a second request corresponding to the link to the configuration utility. For example, user processor 105 may receive the page including the link associated with configuration utility 235. The user operating user processor 105 may initiate the link associated with configuration utility 235. Once initiated on user processor 105, the link may generate the second request. The generated second request may be sent from user processor 105 to RTU processor 205.

After remote terminal unit 110 receives the second request in stage 430, exemplary method 400 may proceed to stage 440 where remote terminal unit 110 may transmit, in response to the second request, configuration utility 235. For example, in response to the second request, RTU processor 205 may transmit configuration utility 235 to user processor 105. Once user processor 105 has configuration utility 235, user processor 105 can execute configuration utility 235 on user processor 105 in order to create configuration file 240, for example, in response to user input into user processor 105. Configuration file 240 may be configured to cause remote terminal unit 110 to operate in a first manner selected from a plurality of manners.

To make a functional configuration file, configuration utility 235 may need the right communication settings. Everything else may work as setup by default. Configuration utility 235 may then generate configuration file 240. For example, input may be provided by the user by typing in the correct data or clicking on a desired option. Configuration file 240 may be formatted in XML, and may be placed on RTU processor 205. RTU processor 205 may then read configuration file 240, parse the information, and change communication and point settings in RTU processor 205 accordingly.

Based on the inputs, configuration utility 235 may create configuration file 240 having, for example, general attributes and specific attributes. General attributes may include point configuration data, protocol data and communication configuration, and calculations data. Specific attributes may include: i) point mapping and renaming data (e.g. master control inhibit, Local/Remote indicator, digital outputs, digital inputs, analog inputs, analog outputs, accumulators, pseudo points); ii) digital input filtering data (e.g. tolerant, intolerant, filter period, chatter filter, transitions per period, event class, event variation); iii) digital output data (e.g. control type, control format); iv) analog input data (e.g. deadband, event class, event variation); v) accumulators (e.g. event class, event variation); and vi) protocol data (e.g. protocol selection, master/slave selection, host name, port number, connection type, baud rate, data bits, parity, stop bits, transmit delay, response timeout, idle timeout, encryption enable, bit rotation, XOR Mask, key entry, master address, slave address, service type, datalink retries, multiple application layer properties, multiple collision avoidance settings, multiple unsolicited messages settings, and advanced settings.)

Once configuration file 240 is created on user processor 105, user processor may send the created configuration file 240 to RTU processor 205 where it may be stored in memory 230. In operation, RTU 110 may use configuration file 240 to configure RTU 110. After remote terminal unit 110 receives and saves configuration utility 240, exemplary method 400 may then end at stage 450.

Consistent with another embodiment of the invention, RTU processor 205 may function as a web server executing the configuration utility in order to create the configuration file. For example, through network 120, user processor 105 may request and receive pages from RTU processor 205 thus executing the configuration utility in order to create the configuration file. In this embodiment, rather than downloading the configuration utility to and running it on user processor 105, under the direction of user processor 105, the configuration utility may be ran on RTU processor 205 in order to create the configuration file.

Generally, consistent with embodiments of the invention, program modules may include routines, programs, components, data structures, and other types of structures that perform particular tasks or implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention may exist. Furthermore, although embodiments of the present invention have been described as being associated with data stored in memory and other storage mediums, aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering stages and/or inserting or deleting stages, without departing from the principles of the invention.

It is intended, therefore, that the specification and examples be considered as exemplary only, with a true scope and spirit of the invention being indicated by the following claims and their full scope of equivalents. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for providing a configuration utility for a remote terminal unit, the method comprising:
receiving, at the remote terminal unit, a first request for a page;
transmitting, from the remote terminal unit, the page including a link associated with the configuration utility, the configuration utility being stored on the remote terminal unit and configured to create, based on user input, a configuration file for the remote terminal unit;
receiving, at the remote terminal unit, a second request corresponding to the link to the configuration utility; and
transmitting from the remote terminal unit, in response to the second request, the configuration utility.

2. The method of claim 1, further comprising receiving the configuration file at the remote terminal unit.

3. The method of claim 2, wherein receiving the configuration file comprises receiving the configuration file from a user processor.

4. The method of claim 2, wherein receiving the configuration file comprises receiving the configuration file configured to cause the remote terminal unit to operate in a first manner selected from a plurality of manners.

5. The method of claim 2, wherein receiving the configuration file comprises receiving the configuration file configured to cause the remote terminal unit to operate in a first manner selected from a plurality of manners, the configuration file created by the configuration utility executed on a user processor.

6. The method of claim 2, wherein receiving the configuration file comprises receiving the configuration file configured to cause the remote terminal unit to operate in a first manner selected from a plurality of manners, the configuration file created by the configuration utility received from the remote terminal unit and executed on a user processor.

7. The method of claim 2, wherein receiving the configuration file comprises receiving the configuration file configured to cause the remote terminal unit to operate in a first manner selected, based upon user input, from a plurality of manners, the configuration file created by the configuration utility received from the remote terminal unit and executed on a user processor.

8. A remote terminal unit configured for providing a configuration utility, the remote terminal unit comprising:
a memory storage; and
a processing unit coupled to the memory storage, wherein the processing unit is operative to:
receive, at the remote terminal unit, a first request for a page;
transmit, from the remote terminal unit, the page including a link associated with the configuration utility, the configuration utility being stored on the remote terminal unit and configured to create, based on user input, a configuration file for the remote terminal unit;
receive, at the remote terminal unit, a second request corresponding to the link to the configuration utility; and
transmit from the remote terminal unit, in response to the second request, the configuration utility.

9. The remote terminal unit of claim 8, wherein the processing unit is further operative to receive the configuration file.

10. The remote terminal unit of claim 9, wherein the processing unit operative to receiving the configuration file comprises the processing unit operative to receive the configuration file from a user processor.

11. The remote terminal unit of claim 9, wherein the processing unit operative to receive the configuration file comprises the processing unit operative to receive the configuration file configured to cause the remote terminal unit to operate in a first manner selected from a plurality of manners.

12. The remote terminal unit of claim 9, wherein the processing unit operative to receive the configuration file comprises the processing unit operative to receive the configuration file configured to cause the remote terminal unit to operate in a first manner selected from a plurality of manners, the configuration file created by the configuration utility executed on a user processor.

13. The remote terminal unit of claim 9, wherein the processing unit operative to receive the configuration file comprises the processing unit operative to receive the configuration file configured to cause the remote terminal unit to operate in a first manner selected from a plurality of manners, the configuration file created by the configuration utility received from the remote terminal unit and executed on a user processor.

14. The remote terminal unit of claim 9, wherein the processing unit operative to receive the configuration file comprises the processing unit operative to receive the configuration file configured to cause the remote terminal unit to operate in a first manner selected, based upon user input, from a plurality of manners, the configuration file created by the configuration utility received from the remote terminal unit and executed on a user processor.

15. A remote terminal unit comprising:
a remote terminal unit processor; and
an input/output component electrically isolated from the remote terminal unit processor wherein the remote terminal unit processor and the input/output component are both located on a circuit board wherein a first space is maintained on the circuit board between the remote terminal unit processor and the input/output component, the first space having a first width configured to cause the remote terminal unit processor to be isolated from an electrical surge between the remote terminal unit processor and the input/output component.

16. The remote terminal unit of claim 15, wherein the first width is configured to cause the remote terminal unit processor to be isolated from the electrical surge of less than or equal to 2.5 kV oscillatory and approximately 4 kV transient.

17. The remote terminal unit of claim 15, wherein the remote terminal unit processor is communicatively non-electrically coupled to the input/output component.

18. The remote terminal unit of claim 15, wherein the remote terminal unit further comprises a power supply located on the circuit board wherein a second space is maintained on the circuit board between the remote terminal unit processor and the power supply, the second space having a second width configured to cause the remote terminal unit processor to be isolated from an electrical surge between the remote terminal unit processor and the power supply.

19. The remote terminal unit of claim 18, wherein the second width is configured to cause the remote terminal unit processor to be isolated from the electrical surge of less than or equal to 2.5 kV oscillatory and approximately 4 kV transient originating from the power supply.

20. The remote terminal unit of claim 15, wherein the remote terminal unit further comprises a power supply located on the circuit board wherein a third space is maintained on the circuit board between the input/output component and the power supply, the third space having a third width configured to cause the input/output component to be isolated from an electrical surge between the input/output component and the power supply.

21. The remote terminal unit of claim 20, wherein the third width is configured to cause the input/output component to be isolated from the electrical surge of less than or equal to 2.5 kV oscillatory and approximately 4 kV transient originating from the power supply.

22. A computer-readable medium which stores a set of instructions which when executed performs a method for providing a configuration utility for a remote terminal unit, the method executed by the set of instructions comprising:
receiving, at the remote terminal unit, a first request for a page;
transmitting, from the remote terminal unit, the page including a link associated with the configuration utility, the configuration utility being stored on the remote terminal unit and configured to create, based on user input, a configuration file for the remote terminal unit;
receiving, at the remote terminal unit, a second request corresponding to the link to the configuration utility;
transmitting from the remote terminal unit, in response to the second request, the configuration utility; and
receiving, at the remote terminal unit, the configuration file configured to cause the remote terminal unit to operate in a first manner selected, based upon user input, from a plurality of manners, the configuration file created by the configuration utility received from the remote terminal unit and executed on a user processor.
